(19) United States
(12) Patent Application Publication
(10) Pub. No.: US 2022/0128680 A1
(43) Pub. Date: Apr. 28, 2022

(54) Method and Apparatus for Sensor Data Fusion for a Vehicle

(71) Applicant: Bayerische Motoren Werke Aktiengesellschaft, Muenchen (DE)

(72) Inventors: Dominik BAUCH, Muehldorf am Inn (DE); Marco BAUMGARTL, Gilching (DE); Michael HIMMELSBACH, Muenchen (DE); Josef MEHRINGER, Gmund (DE); Daniel MEISSNER, Friedberg (DE); Luca TRENTINAGLIA, Eichenau (DE)

(21) Appl. No.: 17/427,986

(22) PCT Filed: Oct. 25, 2019
(86) PCT No.: PCT/EP2019/079224

§ 371 Date: Aug. 3, 2021

(30) Foreign Application Priority Data
Feb. 6, 2019 (DE) 10 2019 102 920.1

(51) Int. Cl. G01S 13/86; G01S 13/72; G01S 13/931

(52) U.S. Cl. CPC G01S 13/86; G01S 13/862; G01S 13/931; G01S 13/867; G01S 13/726; G01S 13/865

(57) ABSTRACT

A method for sensor data fusion for a vehicle includes providing current sensor object data that are representative of a sensor object sₜ ascertained at the time t; providing fusion object data that are representative of fusion objects fₜ^{j}′ intended for sensor data fusion at the time t; providing a sensor object data record H including historical sensor object data that are representative of a sensor object sₜ₋ₖⁱ, ascertained at a preceding time t−k; taking the sensor object data record H as a basis for ascertaining a reduced sensor object data record H′={Sₜ₋ₖ^{α}t−k|k=1 . . . n}, wherein sₜ [symbol] denotes a sensor object associated with a fusion object fₜ at the time t; and taking the reduced sensor object data record H′ as a basis for associating the sensor object sₜ with a fusion object fₜ^{j} and ascertaining a refreshed fusion object.

### BACKGROUND AND SUMMARY OF THE INVENTION

The invention relates to a method and an apparatus for sensor data fusion for a vehicle. The invention further relates to a computer program and to a computer-readable storage medium.

For the recognition of objects in the surroundings of a vehicle, in particular for the recognition of other road users and relevant properties thereof, heterogeneous sensor apparatuses are often employed. Objects recognized in the surroundings of the vehicle can be used for the secure implementation of assistance functions, in particular for longitudinally regulating functions such as active cruise control or an intersection assistant, and for transversely regulating functions such as lateral collision avoidance, steering and lane keeping assistants.

The information captured by the sensor apparatuses about the objects can differ as a result of the different measuring principles of the sensor apparatuses used. Due to the limited computing capacity in vehicles, the information made available by the sensor apparatuses is usually fused at a high level. This means that the sensor apparatuses each separately recognize objects with reference to the captured information, and make this available as information in an abstract, sensor-independent object representation (known as “sensor objects”); the information provided is then combined or fused by a separate sensor data fusion unit to one respective object representation for each actual object (known as “fusion objects”).

“Smart” sensor apparatuses are typically installed for this purpose, whose recognition performance is based on a subsequent, internal information processing in addition to the physical surveying of the surroundings. A significant element of this information processing is that of recursive estimation processes that can also observe object properties over time, where the properties cannot be determined directly from a single measurement. In addition to an estimation of the object properties of other road users, the recursive estimation process can also supply a measure of their uncertainty.

As a result of the recursive formulation of the estimation process, it is possible that the sensor object data supplied by the sensor apparatuses is not statistically independent of the sensor object data at an earlier time. Since various sensor apparatuses furthermore are often based on similar estimation processes, and in part even receive the same input data, perhaps related to the movement of the vehicle itself, it can also be the case that the sensor object data of different sensor apparatuses also are not statistically independent of one another. To fuse sensor object data that is correlated in this way, what is known as an information matrix fusion (IMF) algorithm can be employed, in which the recursive estimation process is supplemented by a de-correlation of the sensor object data. In this context, reference is made to the remarks of Aeberhard, M., Rauch, A., Rabiega, M., Kaempchen, N., & Bertram, T. (2012, June) in “Track-to-track fusion with asynchronous sensors and out-of-sequence tracks using information matrix fusion for advanced driver assistance systems”, Intelligent Vehicles Symposium (IV), 2012 IEEE (pp. 1-6).

To de-correlate the sensor object data the IMF algorithm requires, in the theoretical worst case, an infinitely long history of all sensor object data, and this is not available, in particular due to the limited memory resources on the embedded systems employed in vehicles. A further disadvantage of the IMF algorithm are the assumptions on which the sensor object data are based, in particular with regard to the reported uncertainties, which in practice are often violated. The IMF algorithm then delivers partially inconsistent estimates with grossly erroneous object properties, wherein the error is not appropriately reflected in the ascertained uncertainty and, in contrast, uncertainties that are too small are output. This can lead to a grossly erroneous behavior in the assistance functions that follow the fusion.

The object on which the invention is based is that of providing a method for sensor data fusion for a vehicle and a corresponding apparatus, a computer program and computer-readable storage medium that contributes to a reliable association between sensor objects and fusion objects and enables a reliable sensor data fusion.

The object is achieved through the claimed invention.

According to a first aspect, the invention relates to a method for sensor data fusion for a vehicle. A sensor apparatus is assigned to the vehicle.

Current sensor object data are provided in the method. The current sensor object data are representative of a sensor object sₜ ascertained by the sensor apparatus in the surroundings of the vehicle at a time t.

A fusion object data set is moreover provided. The fusion object data set comprises fusion object data, which are in each case representative of one fusion object fₜ^{j} out of j=1 . . . p ascertained in the surroundings of the vehicle. The fusion objects fₜ^{j} are each provided for sensor data fusion at the time t.

A sensor object data set H={sₜ₋ₖⁱ|i=1 . . . q, k=1 . . . n} is furthermore provided. The sensor object data set H comprises historic sensor object data, which are in each case representative of one sensor object sₜ₋ₖⁱ, out of i=1 . . . q ascertained by the sensor apparatus in the surroundings of the vehicle at a preceding time t−k, where n, q≥1.

A reduced sensor object data set H′={sₜ₋ₖ [symbol] _{|k=}1 . . . n} is ascertained in the method depending on the sensor object data set H. sₜ^{a}^{ₜ} here identifies a sensor object associated with a fusion object fₜ^{j} at a time t.

Depending on the reduced sensor object data set H′ the sensor object sₜ is furthermore associated with a fusion object fₜ^{j}, and a refreshed fusion object is ascertained.

The proposed method advantageously enables a secure and efficient association between sensor and fusion objects. The method contributes in particular to a reliable fusion of correlated sensor object data.

The sensor apparatus is designed to capture the surroundings of the vehicle and to ascertain a sensor object in the surroundings of the vehicle. The sensor apparatus can in particular be designed to capture a lateral extent and/or orientation of an object. The sensor apparatus can, for example, be a camera, lidar (light detection and ranging), ladar (laser detection and ranging), radar (radio detection and ranging), ultrasonic, point laser or infrared sensor.

The sensor object data set H comprises historic sensor object data of the same sensor apparatus. In the event that m>1 different sensor apparatuses are assigned to the vehicle, a sensor object data set H₁ . . . Hₘ is provided for each sensor apparatus, and the corresponding steps of the method are carried out once for each sensor apparatus.

The reduced sensor object data set H′={sₜ₋ₖ^{a} [symbol] |k=1 . . . n} comprises in particular only more such sensor objects sₜ₋ₖⁱ of the sensor object data set H that were previously associated with an arbitrary fusion object fₜ₋ₖ^{j} at the corresponding time t−k. Thus, in an advantageous manner, instead of recording all q of the sensor objects sₜⁱ, i= . . . q ascertained by the sensor apparatus at the time t, only the p≤q objects sₜⁱ, i=1 . . . p actually associated with a fusion object are included in the association history {sₜ₋ₖⁱ|i=1 . . . p, k=1 . . . n}. In doing so, a unique association history can be recorded for each sensor apparatus independently of the association histories of other sensor apparatuses.

Usually, at each time t, furthermore at most one sensor object sₜⁱ, i=1 . . . p of each sensor apparatus is associated with the same fusion object fₜ^{j}. It is then sufficient to assign only one sensor object sₜ₋ₖ^{α} [symbol] , k=1 . . . n as the reduced sensor object data set H′ to the respective fusion object fₜ^{j} for each time t for each sensor apparatus. In the event that m>1 sensor apparatuses are assigned to the vehicle, it follows that the small number of sensor objects sₜ₋ₖ^{α} [symbol] , k=1 . . . n most recently associated in each case with the respective fusion object fₜ₋ₖⁱ can be noted for each fusion object fₜ^{j}.

The step in which, depending on the reduced sensor object data set H′ the sensor object si is associated with a fusion object fₜ^{j} and a refreshed fusion object is ascertained can, for example, correspond to the IMF algorithm, wherein, instead of an infinitely long or complete history, use is made of the reduced sensor object data set h′.

In one advantageous configuration according to the first aspect: 1≤n≤5, preferably n=2.

One-off ambiguities can advantageously be handled in this way. An efficient utilization of hardware with limited resources is at the same time enabled.

In a further advantageous configuration according to the first aspect, the sensor object sₜ is associated with a fusion object fₜ^{j} by the information matrix fusion IMF algorithm, and the refreshed fusion object is ascertained.

In a further advantageous configuration according to the first aspect, the reduced sensor object data set H′ is in each case assigned to the fusion objects fₜ^{j} and stored in the fusion object data.

Depending on the fusion object data set, the sensor object s*is thereupon associated with a fusion object fₜ^{j}, and the refreshed fusion object is ascertained.

In this configuration, the sensor object sₜ can thus, depending in particular on the reduced sensor object data sets H′ assigned to each of the fusion objects fₜ^{j}, be associated with a fusion object fₜ^{j}, and the refreshed fusion object is accordingly ascertained.

In a further advantageous configuration according to the first aspect, in the event that the reduced sensor object data set H′ assigned to a respective fusion object fₜ^{j} does not comprise an associated sensor object sₜ₋ₖ^{α} [symbol] at any preceding time t−k, k=1 . . . n, the sensor object sₜ is associated with a fusion object fₜ^{j} by using the cross-covariance algorithm, and the refreshed fusion object is ascertained. With reference to the use of the cross-covariance algorithm, reference is made to the remarks of S. Matzka and R. Altendorfer in “A comparison of track-to-track fusion algorithms for automotive sensor fusion”, 2008 IEEE International Conference on Multisensor Fusion and Integration for Intelligent Systems, Seoul, 2008, pp. 189-194. In other words, in the event of an insufficient history, use can be made of an alternative fusion method instead of the IMF algorithm. In particular, the fusion is carried out here with only approximate consideration of possible correlations.

In a further advantageous configuration according to the first aspect, feature data x [symbol] ^{s}, x [symbol] ^{s} are assigned to the sensor object sₜ₋₁, sₜ. The feature data x [symbol] , x [symbol] are representative of a lateral extent, position and orientation of the sensor object sₜ₋₁, sₜ. Indicator data pₓ [symbol] , pₓ [symbol] are further assigned to the sensor object sₜ₋₁, sₜ. The indicator data pₓ [symbol] , pₓ [symbol] are representative of an uncertainty in the ascertainment of the lateral extent, position or orientation.

Feature data xₜ₋₁^{f}, xₜ^{f} are furthermore assigned to the fusion object fₜ₋₁^{j}, fₜ^{j}. The feature data xₜ₋₁^{f}, xₜ^{f} are representative of a lateral extent, position and orientation of the fusion object fₜ₋₁^{j}, fₜ^{j}. Indicator data pₓ_{ₜ₋₁}^{f}, pₓ_{ₜ₋₁}^{f} are further assigned to the fusion object fₜ₋₁^{j}, fₜ^{j}. The indicator data pₓ_{ₜ₋₁}^{f}, pₓ_{ₜ₋₁}^{f} are representative of an uncertainty in the ascertainment of the lateral extent, position or orientation.

A feature fusion state xₜ₋₁ [symbol] is ascertained in the method depending on the feature data xₜ₋₁ [symbol] , x [symbol] ^{f}. The feature fusion state xₜ₋₁ [symbol] is representative of the lateral extent, position and orientation of the fusion object fₜ₋₁^{j} at the time t following the sensor data fusion with xₜ₋₁ [symbol] .

In addition, a refreshed feature fusion state x [symbol] is ascertained depending on the feature data x [symbol] ^{s}, x [symbol] ^{f} and on the indicator data p [symbol] , p [symbol] ^{f}. The refreshed feature fusion state x [symbol] ^{f} is representative of the lateral extent, position and orientation of the fusion object fₜ^{j} at the time t following the sensor data fusion with xₜ^{s}.

A check is thereupon made, depending on the feature fusion state x [symbol] the refreshed feature fusion state x [symbol] ^{f}, and the feature data xₜ [symbol] , as to whether the refreshed feature fusion state x [symbol] ^{f} satisfies the equation min(x_{t-1;t}^{f}, xₜ [symbol] )≤x_{t;t}^{f≤max(x}ₜ₋₁ [symbol] hu f, xₜ^{s}). In the event that the equation is satisfied, the refreshed fusion object is ascertained depending on the refreshed feature state x_{t;t}^{f}. Otherwise, the sensor object sₜ is associated with a fusion object fₜ^{j} by using the cross-covariance algorithm, and the refreshed fusion object is ascertained.

Error cases that are in particular typical for the IMF algorithm can thus be advantageously avoided, wherein the feature data xₜ^{f} of the fusion object fₜ^{j} differs grossly from the feature data xₜ^{s} of the sensor object sₜ. In this case again use can be made of an alternative fusion method instead of the IMF algorithm.

Both the feature fusion state x [symbol] ^{f} and the refreshed feature fusion state x_{t;t}^{f} are in particular representative of a result, stored temporarily for checking, of a fusion between fusion object and sensor object according to the IMF algorithm.

The equation is in particular representative of the fact that the updated properties following the fusion lie between the original properties and the properties of the fused sensor object. If the equation is violated, the temporarily stored result is discarded.

In addition to the lateral extent, position and orientation of the respective object, the corresponding feature data can also comprise further properties of the object, such as its speed and acceleration components and its yaw rate. The lateral extent refers here to an extent of the object both parallel to and transverse to the direction of measurement or travel, or the longitudinal axis of the vehicle. The orientation refers in particular to an angle enclosed by a longitudinal axis of the object and the measuring or travel direction or the longitudinal axis of the vehicle. The position of the object can, for example, refer to a reference point of the object with respect to which the other properties of the object are quoted.

According to a second aspect, the invention relates to an apparatus for sensor data fusion for a vehicle. The apparatus is designed to carry out a method according to the first aspect. The apparatus can also be referred to as the sensor data fusion unit.

According to a third aspect, the invention relates to a computer program for sensor data fusion for a vehicle. The computer program comprises commands which, when the program is carried out by a computer, cause this to carry out the method according to the first aspect.

According to a fourth aspect, the invention relates to a computer-readable storage medium on which the computer program according to the third aspect is stored.

Exemplary embodiments of the invention are explained in more detail below with reference to the schematic drawings.

### BRIEF DESCRIPTION OF THE DRAWINGS

FIG. 1 shows an exemplary vehicle with an apparatus for sensor data fusion.

FIG. 2 shows an exemplary flowchart of a method for sensor data fusion.

FIG. 3 shows an exemplary association between a respective reduced sensor object data set and fusion objects.

### DETAILED DESCRIPTION OF THE DRAWINGS

Elements of the same design or function are given the same reference signs throughout the figures.

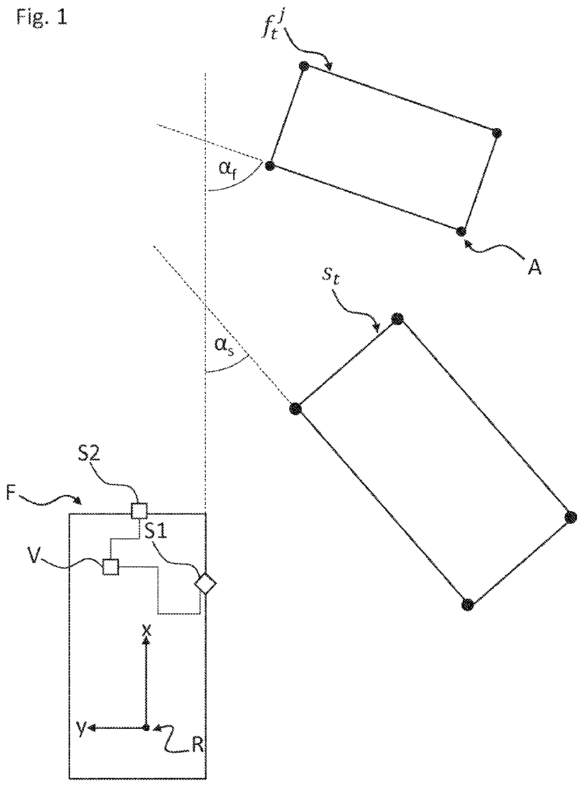

A method for high-level object fusion based on the information matrix fusion (IMF) algorithm, which permits a reliable use in embedded systems, is proposed below. On the basis of the exemplary embodiment of FIG. 1, a vehicle F according to embodiments of the invention with an apparatus V for sensor data fusion and a sensor apparatus S1 that is configured for the capture of objects, in particular other road users and relevant properties thereof, and for the ascertainment of a corresponding sensor object sₜ, is illustrated. This can, for example, be a camera, lidar (light detection and ranging), ladar (laser detection and ranging), radar (radio detection and ranging), ultrasonic, point laser or infrared sensor. Regardless of the method used for high-level object fusion, in the automobile field a list of rectangles or squares is usually output as the result of the object fusion as object representations, representing recognized, and in particular moving, objects in the surroundings of the vehicle F. FIG. 1 shows such a fusion object fₜ^{j}, to which, for example, a reference point A, a length and a width with respect to the reference point A, and an orientation α_{f} of the fusion object fₜ^{j} with respect to a reference coordinate system R of the vehicle F are assigned as relevant properties. Indicator data that are representative of an uncertainty in the ascertainment of the length, width and orientation αₛ can, moreover, be assigned to the fusion object fₜ^{j}. The uncertainty can, for example, be expressed by a variance. FIG. 1 further shows a sensor object sₜ ascertained by the sensor apparatus S1.

The vehicle F further comprises by way of example a further sensor apparatus S2, that is also configured for capture of the surroundings of the vehicle F. The sensor apparatuses S1, S2 are signal-coupled to the apparatus V for sensor data fusion. Sensor object data provided by the sensor apparatuses S1, S2 can be fused by the apparatus V in accordance with any method for high-level object fusion, and stored in a fusion object data set.

The method for high-level object fusion can involve a recursive estimation process on the basis of the information matrix fusion (IMF) algorithm.

It emerges from the formal description of the IMF algorithm that for every sensor object sₜ={xₜ^{s}, p [symbol] ^{s}} with properties xₜ^{s} and their uncertainties p [symbol] that are to be fused at the time t to one of j=1 . . . p fusion objects fₜ^{j}, the state of the sensor object sₜ₋ₖ at the last fusion time must be known. Since in theory very large values of k>>1 are possible, it is not readily possible to make all the information required for the IMF algorithm available on an embedded system with low memory resources.

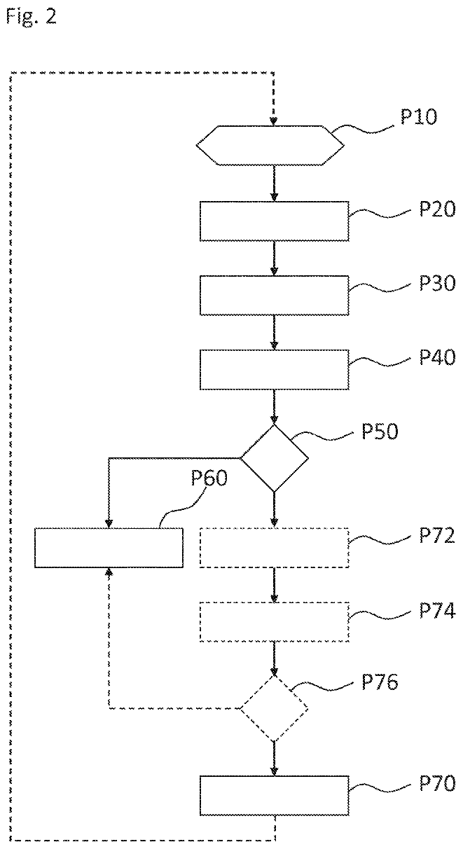

In this context, a data and program memory is in particular assigned to the apparatus V, in which a computer program that is explained below in more detail with reference to the flowchart of FIG. 2 is stored.

In a first step P10, a current sensor object data that are representative of a sensor object sₜ ascertained by the sensor apparatus S1 in the surroundings of the vehicle F at a time t are provided. In particular, a plurality of sensor object data can be ascertained in this step by the sensor apparatus S1, so that altogether q>1 different sensor objects sₜⁱ, i=1 . . . q ascertained by the sensor apparatus S1 are provided. For example, in the first step P10 current sensor object data of the further sensor apparatus S2 can also be provided.

The program is continued in a step P20, in which a fusion object data set is provided. The fusion object data set comprises fusion object data, which are in each case representative of one fusion object fₜ^{j} out of j=1 . . . p ascertained in the surroundings of the vehicle F, that are each provided at the time t for sensor data fusion. The fusion object data set is, for example, stored in a data memory of the apparatus V, and was ascertained in a preceding fusion process from the sensor object data of the sensor apparatuses S1, S2.

A sensor object data set H={sₜ₋ₖⁱ|i=1 . . . m, k≤1 . . . n} is provided in a subsequent step P30. The sensor object data setH comprises historic sensor object data, which are in each case representative of one sensor object sₜ₋ₖⁱ, out of i=1 . . . m ascertained by the sensor apparatus S1 in the surroundings of the vehicle F at a preceding time t-k, where n, m≥1. For example, in the first step P30 a sensor object data set of the further sensor apparatus S2 can also be provided.

The sensor object data set H can also be referred to as the association history. A fusion only results from a previous association of sensor object and fusion object. Thus instead of recording all q of the sensor objects sₜⁱ, i=1 . . . q recognized by the sensor apparatus S1 at the time t, it is sufficient to include only the p≤q sensor objects sₜⁱ, i=1 . . . p actually associated with a fusion object in the association history. In other words, in a step preceding the step P30 and following the step P10 in which the current sensor data are ascertained, it is possible for a selection to be made each time as to which of the ascertained current sensor data are included in the association history. In doing so, a unique association history can be recorded for each sensor apparatus S1, S2 independently of the association histories of other sensor apparatuses in the fusion system. Only the association history of the sensor apparatus S1 will therefore be considered below.

The method is continued in a step P40 that follows step P30, in which, depending on the sensor object data set H, a reduced sensor object data set H′={sₜ₋ₖ^{α}^{ₜ₋ₖ}|k=1 . . . n} is ascertained, wherein sₜ^{α}^{ₜ} refers to a sensor object associated at the time t with a fusion object fₜ. The reduced sensor object data set H′ is then assigned to the respective fusion objects fₜ^{j} and stored in the fusion object data.

For the sensor object data set H, the necessity of n>1 only results from a possible association of different sensor objects at different times with the same fusion object. It can, however, usually be assumed that the sensor apparatus S1 continuously tracks the objects in the surroundings of the vehicle F, and it is only in dense traffic situations that ambiguous object formations can result, so that an actual object in the surroundings results in the formation of multiple sensor objects (separated in space or time). In addition, at any time no more than one object of the sensor apparatus S1 is associated with the same fusion object.

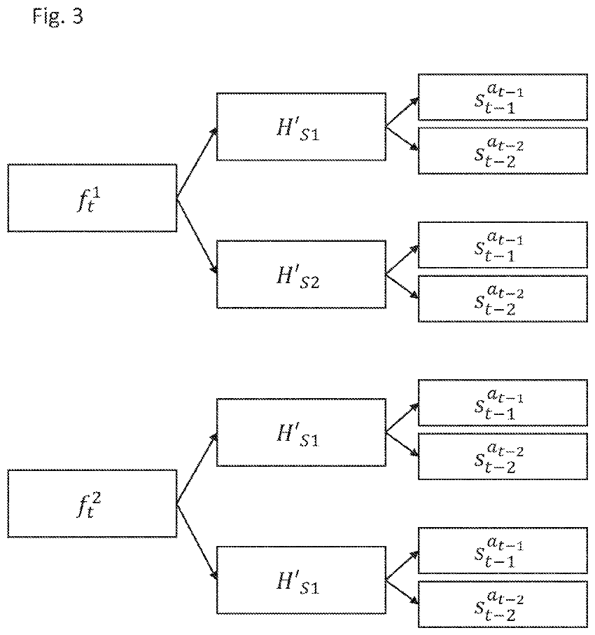

It is therefore sufficient to note the few sensor objects sₜ₋ₖ^{α} [symbol] , k=1 . . . n most recently associated with a fusion object at the fusion object. The history thus now contains different sensor objects at different times, H′={sₜ₋ₖ [symbol] |k=1 . . . n}. A value of n=2 has been found appropriate in practice, so that one-off ambiguities can be handled. The resulting model, with n=2, for the realization of the association history is shown in FIG. 3. A reduced sensor object data set H′_{S1} of the sensor apparatus S1 and a reduced sensor object data set H′_{S1} of the further sensor apparatus S2 are here respectively assigned to each fusion object fₜ¹, fₜ². The reduced sensor object data set H′_{S1} here comprises the sensor objects sₜ₋₁^{α} [symbol] and sₜ₋₂^{α} [symbol] of the sensor apparatus S1 associated at the times t−1 and t−2, while the reduced sensor object data set H′_{S2} comprises the sensor objects sₜ₋₁^{α} [symbol] and sₜ₋₂^{α} [symbol] of the further sensor apparatus S2 associated at the times t−1 and t−2.

In a subsequent step P50, depending on the reduced sensor object data set H′, the sensor object sₜ is associated with a fusion object fₜ^{j}, and a refreshed fusion object is ascertained.

To this end a check is first made as to whether the reduced sensor data set H′ assigned to the respective fusion object fₜ^{j} comprises a sensor object sₜ₋ₖ^{α}^{ₜ₋ₖ} associated at an earlier time t−k, k=1 . . . n.

In the event that the reduced sensor object data set H′ does not comprise an associated sensor object sₜ₋ₖ^{α}^{ₜ₋ₖ} at any preceding time t−k, k=1 . . . n, the sensor object sₜ is associated in a step P60 with a fusion object fₜ^{j} by using the cross-covariance algorithm, and the refreshed fusion object is ascertained. Otherwise the sensor object sₜ is associated in a step P70 with a fusion object fₜ^{j} by the information matrix fusion (IMF) algorithm on the basis of the reduced sensor object data set h′, and a refreshed fusion object is ascertained.

If no fused sensor object related to an earlier time can be found in the limited association history explained above, for example during the first fusion of the sensor object, or because the choice of q cannot resolve the ambiguity of the sensor apparatus, the fusion is only applied with approximative consideration of possible correlations using the cross-covariance method.

The program is subsequently ended or, possibly following a specified interruption, continued in step P10 with an updated object data set.

In an alternative variant embodiment, the step P70 is supplemented with a plausibility check of the refreshed fusion object.

In the practical application of the IMF algorithm for the fusion of the sensor object data of multiple sensor apparatuses on an embedded system, an error case can occur that results in the determination of fused properties that deviate grossly from the properties reported by the corresponding sensor apparatus.

In this variant embodiment, feature data xₜ₋₁ [symbol] , xₜ^{s} are assigned to the respective sensor object sₜ₋₁, sₜ, that are representative of the properties reported by the sensor apparatus, such as a lateral extent, position and orientation of the sensor object sₜ₋₁, sₜ. Indicator data pₓ [symbol] ^{s}, pₓ_{ₜ}^{s} are furthermore assigned to the respective sensor object sₜ₋₁, sₜ, that are representative of an uncertainty in the ascertainment of the properties.

Similarly, feature data xₜ₋₁^{f}, xₜ^{f} that are representative of the properties of the corresponding fusion object fₜ₋₁^{j}, fₜ^{j} and indicator data pₓ_{ₜ₋₁}^{f}, pₓ_{ₜ}^{f} that are representative of an uncertainty in the ascertainment of the properties are assigned to the respective fusion object fₜ₋₁^{j}, fₜ^{j}.

In a step P72 that follows the step P50, depending on the feature data xₜ₋₁ [symbol] , xₜ₋₁^{f}, a feature fusion state x [symbol] ^{f} is ascertained that is representative of the properties of the fusion object fₜ₋₁^{j} at the time t following the sensor data fusion with fₜ₋₁ [symbol] .

In a step P74, depending on the feature data xₜ^{s}, x [symbol] ^{f} and on the indicator data p [symbol] , pₓ [symbol] ^{f} a refreshed feature fusion state x [symbol] ^{f} is thereupon ascertained, that is representative of the properties of the fusion object fₜ^{j} at the time t following the sensor data fusion with xₜ^{s}.

Finally, in a step P76, depending on the feature fusion state x [symbol] , the refreshed feature fusion state x [symbol] ^{f}, and the feature data xₜ^{s}, a check is made as to whether the refreshed feature fusion state x_{t;t}^{f} satisfies the equation min(xₜ₋₁ [symbol] ^{f}, xₜ^{s})≤x [symbol] ≤max(xₜ₋₁ [symbol] , xₜ^{s}). In other words, a check is made in the step P76 as to whether the intuitive assumption that the updated properties following the fusion lie between the original properties and the properties of the fused sensor object is violated.

In the event that the equation is satisfied, the refreshed fusion object is ascertained depending on the refreshed feature state x [symbol] ^{f} in the step P70. Otherwise, the sensor object sₜ is associated in the step P60 with a fusion object fₜ^{j} by using the cross-covariance algorithm, and the refreshed fusion object is ascertained.

To handle this error case, the IMF fusion of the fusion and sensor objects is in particular carried out as usual, and the result stored temporarily for checking. If the result violates the intuitive assumption described above, the temporary result is discarded. A fusion instead takes place with only approximative consideration of possible correlations, making use of the cross-covariance method.

1.-9. (canceled)

10. A method for sensor data fusion for a vehicle, wherein a sensor apparatus is assigned to the vehicle, the method comprising:
providing current sensor object data that are representative of a sensor object sₜ ascertained by the sensor apparatus in surroundings of the vehicle at a time t;
providing a fusion object data set comprising fusion object data, each of which is representative of one fusion object fₜ^{j} out of j=1 . . . p fusion objects ascertained in the surroundings of the vehicle and each of which is provided at the time t for sensor data fusion;
providing a sensor object data set H={s [symbol] |i=1 . . . m, k=1 . . . n} comprising historic sensor object data, each of which is representative of one sensor object sₜ₋ₖⁱ, out of i=1 . . . m sensor objects ascertained by the sensor apparatus in the surroundings of the vehicle at a preceding time t−k, where n=1 and m≥1;
ascertaining a reduced sensor object data set H′={sₜ [symbol] |k=1 . . . n} depending on the sensor object set H, wherein sₜ [symbol] refers to a sensor object associated with a fusion object fₜ at the time t;
depending on the reduced sensor object data set H′ associating the sensor object sₜ with a fusion object fₜ^{j}; and
ascertaining a refreshed fusion object.

11. The method according to claim 10, wherein 1≤n≤5.

12. The method according to claim 11, wherein n=2.

13. The method according to claim 10, wherein
the sensor object sₜ is associated with the fusion object fₜ^{j} by the information matrix fusion (IMF) algorithm.

14. The method according to claim 13, wherein:
the reduced sensor object data set H′ is assigned to the respective fusion objects fₜ^{j} and stored in the fusion object data, and
depending on the fusion object data set, the sensor object sₜ is associated with the fusion object fₜ^{j}, and the refreshed fusion object is ascertained.

15. The method according to claim 14, wherein:
the reduced sensor object data set H′ assigned to a respective fusion object fₜ^{j} does not comprise an associated sensor object sₜ₋ₖⁿ [symbol] at any preceding time t−k, k=1 . . . n, the sensor object sₜ is associated with a fusion object fₜ^{j} by using the cross-covariance algorithm.

16. The method according to claim 14, wherein:
feature data xₜ₋₁^{s}, x [symbol] that are representative of a lateral extent, position and orientation of the sensor object sₜ₋₁, sₜ, and indicator data p [symbol] , p [symbol] that are representative of an uncertainty in the ascertainment of the lateral extent, position or orientation, are assigned to the sensor object sₜ₋₁, sₜ;
feature data x [symbol] ^{f}, x [symbol] ^{f}, that are representative of a lateral extent, position and orientation of the fusion object fₜ₋₁^{j}, fₜ^{j}, and indicator data pₓ [symbol] ^{f}, pₓ [symbol] , that are representative of an uncertainty in the ascertainment of the lateral extent, position or orientation, are assigned to the fusion object f [symbol] ^{j}, fₜ^{j};
depending on the feature data x [symbol] , x [symbol] ^{j}, a feature fusion state x [symbol] ^{f} that is representative of the lateral extent, position and orientation of the fusion object f [symbol] ^{j} at the time t following the sensor data fusion with x [symbol] ^{s} is ascertained;
depending on the feature data x [symbol] , x [symbol] ^{f} and on the indicator data pₓ_{ₜ} [symbol] , pₓ [symbol] ^{f}, a refreshed feature fusion state x [symbol] is ascertained that is representative of the lateral extent, position and orientation of the fusion object fₜ^{j} at the time t following the sensor data fusion with xₜ^{s}; and
depending on the feature fusion state x [symbol] ^{f}, the refreshed feature fusion state f [symbol] ^{f} and the feature data xₜ^{s}, a check is made as to whether the refreshed feature fusion state f [symbol] ^{f} satisfies equation min(x [symbol] , x [symbol] )≤x [symbol] ^{f}≤max(x [symbol] ^{f}, x [symbol] ), wherein, if the equation is satisfied, the refreshed fusion object is ascertained depending on the refreshed feature state x [symbol] ^{f}, and if the equation is not satisfied, the sensor object sₜ is associated by using the cross-covariance algorithm with a fusion object fₜ^{j}.

17. An apparatus for sensor data fusion for a vehicle, wherein the apparatus is configured to carry out a method comprising:
providing current sensor object data that are representative of a sensor object sₜ ascertained by the sensor apparatus in surroundings of the vehicle at a time t;
providing a fusion object data set comprising fusion object data, each of which is representative of one fusion object fₜ^{j} out of j=1 . . . p fusion objects ascertained in the surroundings of the vehicle and each of which is provided at the time t for sensor data fusion;
providing a sensor object data set H={s [symbol] |i=1 . . . m, k=1 . . . n} comprising historic sensor object data, each of which is representative of one sensor object sₜ₋ₖⁱ, out of i=1 . . . m sensor objects ascertained by the sensor apparatus in the surroundings of the vehicle at a preceding time t—k, where n=1 and m≥1;
ascertaining a reduced sensor object data set H′={sₜ₋ₖ [symbol] |k=1 . . . n} depending on the sensor object set H, wherein sₜ^{a} [symbol] refers to a sensor object associated with a fusion object fₜ at the time t;
depending on the reduced sensor object data set H′, associating the sensor object sₜ with a fusion object fₜ^{j}; and
ascertaining a refreshed fusion object.

18. A computer product comprising a non-transitory computer readable medium having stored thereon program code which, when executed on a processor, a microcontroller or a programmable hardware component, carries out the acts of:
providing current sensor object data that are representative of a sensor object sₜ ascertained by the sensor apparatus in surroundings of the vehicle at a time t;
providing a fusion object data set comprising fusion object data, each of which is representative of one fusion object fₜ^{j} out of j=1 . . . p fusion objects ascertained in the surroundings of the vehicle and each of which is provided at the time t for sensor data fusion;
providing a sensor object data set H={sₜ₋ₖⁱ|l=1 . . . m, k=1 . . . n} comprising historic sensor object data, each of which is representative of one sensor object sₜ₋ₖⁱ, out of i=1 . . . m sensor objects ascertained by the sensor apparatus in the surroundings of the vehicle at a preceding time t−k, where n=1 and m≥1;
ascertaining a reduced sensor object data set H′={sₜ₋ₖ [symbol] |k=1 . . . n} depending on the sensor object set H, wherein sₜ [symbol] refers to a sensor object associated with a fusion object fₜ at the time t;
depending on the reduced sensor object data set H′, associating the sensor object sₜ with a fusion object fₜ^{j}; and
ascertaining a refreshed fusion object.
